(19) United States
(12) Patent Application Publication
(10) Pub. No.: US 2026/0195108 A1
(43) Pub. Date: Jul. 9, 2026

(54) CONTEXT AWARE TRANSLATION OF SOFTWARE CODE

(71) Applicant: International Business Machines Corporation, Armonk, NY (US)

(72) Inventors: Zvonimir Fras, St Catharines (CA); Rhythm Thakur, Hoshiarpur (IN); Danny Soroker, Larchmont, NY (US); Kaushal Savani, Surat (IN)

(21) Appl. No.: 19/009,787

(22) Filed: Jan. 3, 2025

(51) Int. Cl. G06F 8/51; G06F 8/35

(52) U.S. Cl. CPC G06F 8/51; G06F 8/35

(57) ABSTRACT

A method, according to one approach, includes: generating application images from application source code, and using the application images to generate strings of characters in a source language to be translated. The method also includes generating context associated with the strings of characters. The strings of characters and context are used to produce context-based translations of the strings of characters in a target language. Moreover, a mapper updates the application source code with the translations.

### BACKGROUND

The present invention relates to software code, and more specifically, this invention relates to modifying software code.

Electronic devices like mobile phones have continued to be adopted for a variety of situations in daily life. As electronic devices have become more advanced over time and gained functionality, they have been able to perform a wider array of actions. For instance, individuals can download software applications on their mobile phones. These software applications are each configured to utilize different characteristics of the mobile phones to perform specific actions.

The process of developing software is complex and has conventionally been resource intensive. For instance, software is often tailored for a target operating system, geographic location, etc. Software may thereby be configured to generate and interact with a user interface in a given language, and configuring it for a new language has traditionally required resource-intensive translations.

### SUMMARY

A method, according to one approach, includes: generating application images from application source code, and using the application images to generate strings of characters in a source language to be translated. The method also includes generating context associated with the strings of characters. The strings of characters and context are used to produce context-based translations of the strings of characters in a target language. Moreover, a mapper updates the application source code with the translations.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational view of the components in an AI based model, in accordance with one approach.

FIG. 3A is a flowchart of a method, in accordance with one approach.

FIG. 3B is a flowchart of sub-processes for one or more of the operations in the method of FIG. 3A, in accordance with one approach.

FIG. 3C is a flowchart of sub-processes for one or more of the operations in the method of FIG. 3A, in accordance with one approach.

FIG. 3D is a flowchart of sub-processes for one or more of the operations in the method of FIG. 3A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for automatically generating high quality translations of software based applications. Some approaches use trained AI based models having to translate software code (having strings that call for translation) and/or rendered images of the application. For instance, the rendered images may be used by the AI based models as context for producing the translations. For instance, the AI based models combine rendering application screens, producing descriptions of contexts within those screens, and translating user interface elements while accounting for context. The improvements achieved by approaches herein may thereby be experienced with any software code that uses translation files and/or libraries, and even with software code that is written without factoring translation into account, e.g., as will be described in further detail below.

In one general approach, a method includes: generating application images from application source code, and using the application images to generate strings of characters in a source language to be translated. The method also includes generating context associated with the strings of characters. The strings of characters and context are used to produce context-based translations of the strings of characters in a target language. Moreover, a mapper updates the application source code with the translations.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such new translation code at block 150 for automatically generating high quality translations of software based applications. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

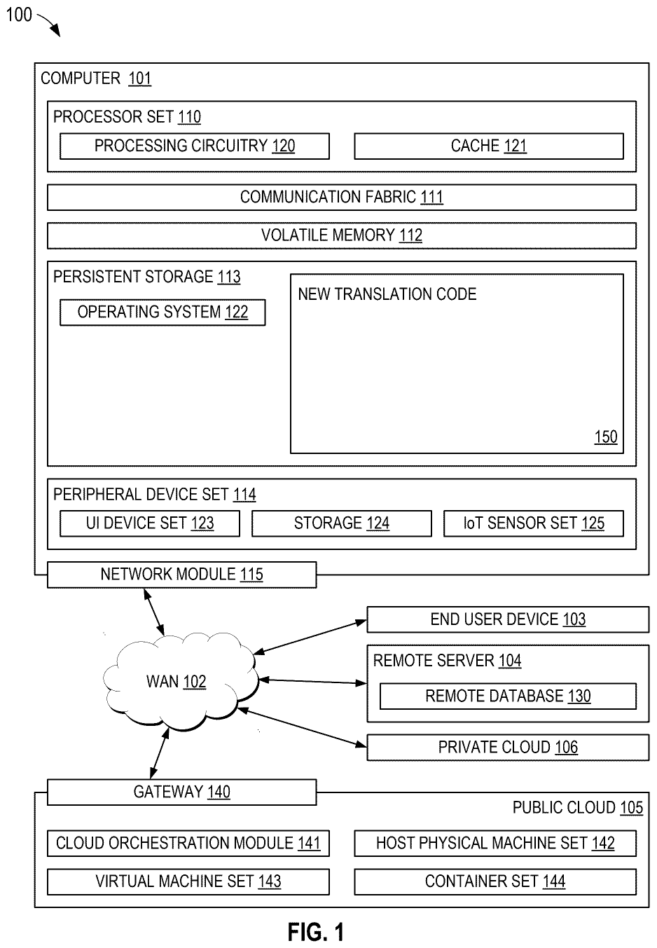

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, the process of developing software is a significantly complex process that has conventionally been resource intensive. For instance, software is often tailored for a target operating system, geographic location, etc. Software may thereby be configured to generate and interact with a user interface in a given language.

The process of changing the software to operate using a different (e.g., “target”) language has proven to be conventionally difficult. Snippets of software pertaining to information that is presented in a user interface are usually short and lack context. These software snippets have thereby proven to be particularly difficult to translate. Rather, conventional approaches have modified software to run in different languages by employing human translators to translate the software strings into the desired target language, which is a resource intensive process. In sharp contrast to conventional shortcomings, approaches herein can automatically generate high quality context-aware machine translations of software code (also referred to herein as “code”). Some approaches use trained AI based models having LLMs to translate application source code (having strings that call for translation) and/or rendered images of the application. The rendered images may be used by the AI based models as context for producing the high-quality machine translations. For instance, the AI based models combine rendering application screens, producing descriptions of contexts within those screens, and translating user interface elements while accounting for context. The improvements achieved by approaches herein may thereby be experienced with any code that uses translation files and/or libraries, and even with code that is written without factoring translation into account, e.g., as will be described in further detail below.

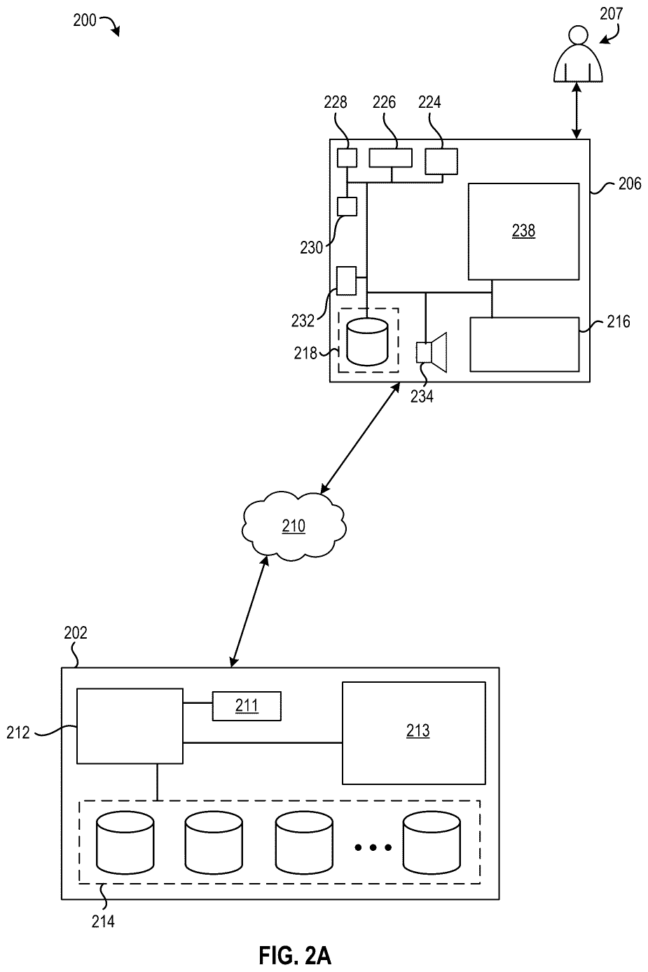

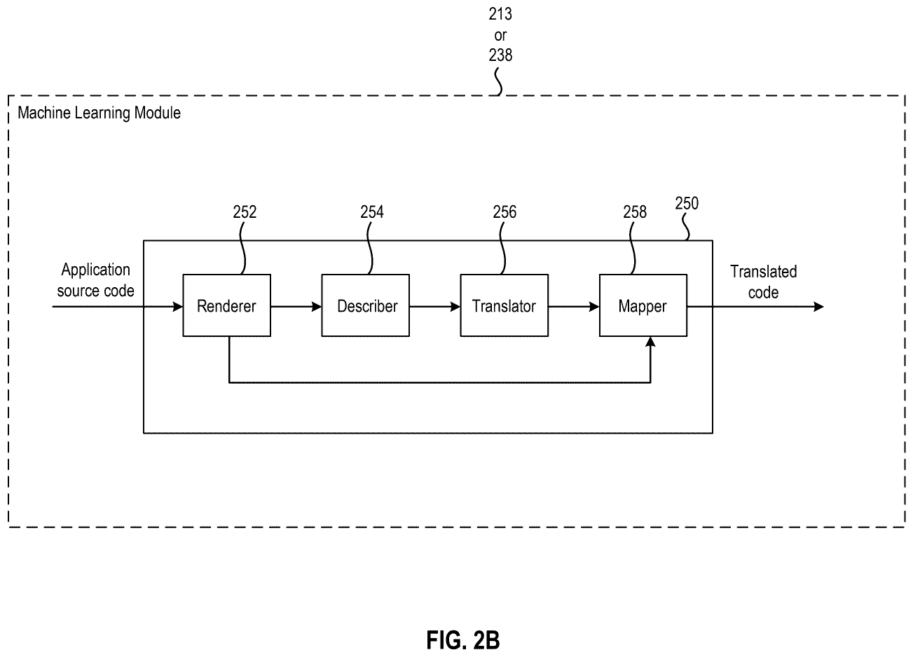

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to an electronic device 206 accessible to the user 207. The electronic device 206 and central server 202 may thereby be separated from each other such that they are positioned in different geographical locations. For instance, the central server 202 and electronic device 206 are connected to a network 210. However, it should be noted that while some approaches herein may be implemented on a single server or a small group of servers, the approaches may be distributed across any desired number of servers in various ways.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user 207 and central server 202 using the electronic device 206, regardless of the amount of separation which exists therebetween, e.g., despite being positioned at different geographical locations.

However, it should be noted that two or more of the electronic device 206 and/or central server 202 may be connected differently depending on the approach. According to an example, which is in no way intended to limit the invention, edge compute nodes may be located relatively close to each other and connected by a wired connection, e.g., a cable, a fiber-optic link, a wire, etc. ; etc., or any other type of connection which would be apparent to one skilled in the art after reading the present description. The term “user” is in no way intended to be limiting either. For instance, while users are described as being individuals in various implementations herein, a user may be an application, an organization, an information technology (IT) department, a preset process, etc. The use of “data” and “information” herein is in no way intended to be limiting either, and may include any desired type of details, e.g., depending on the type of software (e.g., program) being evaluated.

With continued reference to FIG. 2A, the electronic device 206 and central server 202 are shown as having different configurations. For example, the central server 202 includes a large (e.g., robust) processor 212 coupled to a cache 211, a machine learning module 213, as well as a data storage array 214 having a relatively high storage capacity. The machine learning module 213 may include any desired number and/or type of machine learning models. In preferred approaches, the machine learning module 213 includes machine learning models that have been trained to automatically generate high quality translations of software based applications.

Some approaches use trained AI based models (e.g., some of which may include LLMs) to translate application source code (having strings that call for translation) and/or rendered images of the application. The machine learning module 213 may include one or more image-to-text models that are configured to inspect application images, and output strings of characters (e.g., alphanumeric elements) to be translated. In other approaches, the machine learning module 213 may include one or more image-caption models that are configured to inspect strings of characters to be translated, and output the context associated with the strings of characters. The rendered images may thereby be used by the AI based models as context for producing the high-quality machine translations. For instance, the AI based models combine rendering application screens, producing descriptions of contexts within those screens, and translating user interface elements while accounting for context. The improvements achieved by approaches herein may thereby be experienced with any code that uses translation files and/or libraries, and even with code that is written without factoring translation into account, e.g., as will be described in further detail below.

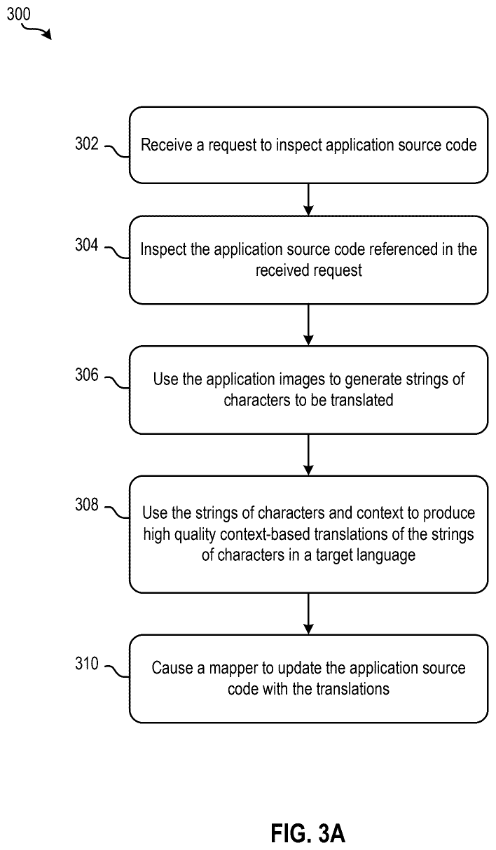

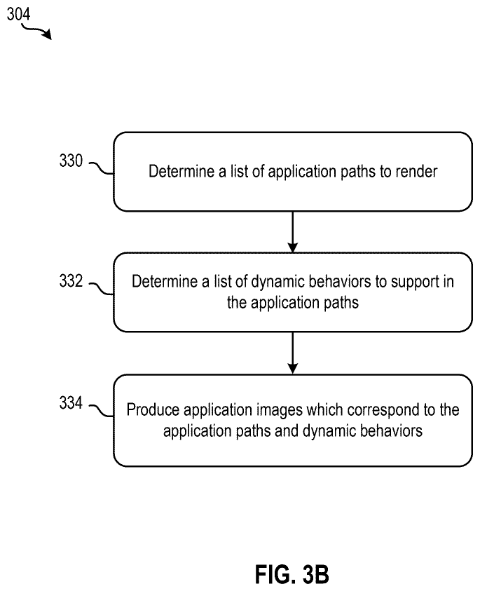

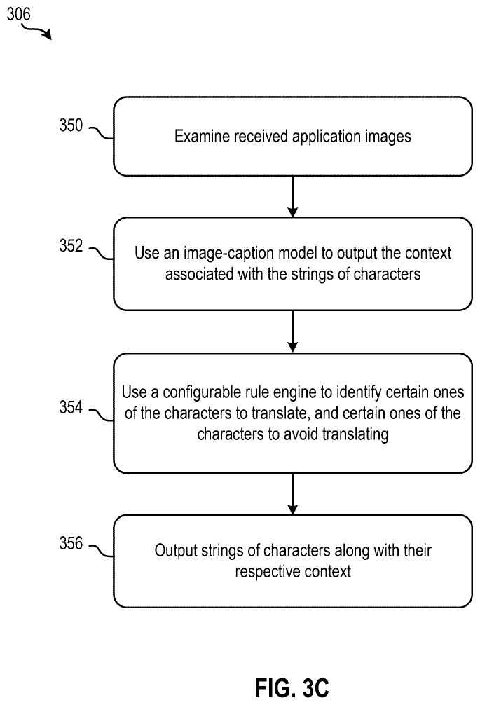

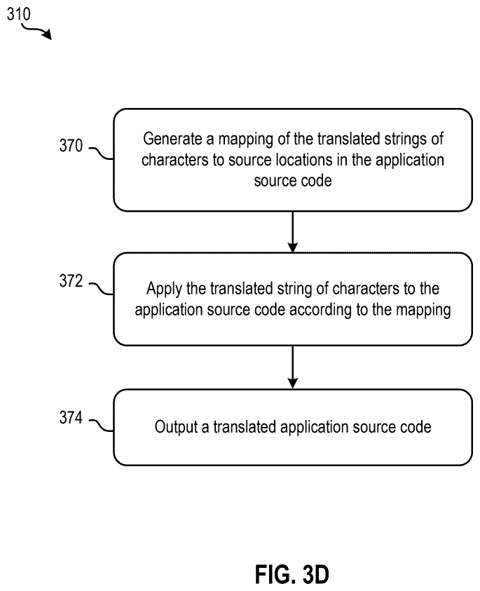

Looking now to FIG. 2B, the logical and/or physical components in a multilingual-machine translation (e.g., AI based) model 250 are depicted in accordance with one approach. It follows that one or more of these components may be used by the machine learning modules 213, 238 of FIG. 2A to automatically translate received application source code. For example, one or more of the components in FIG. 2B may be used by machine learning modules 213 and/or 238 of FIG. 2A to perform operations in method 300 of FIG. 3A. However, it should be noted that the sub-operations of FIG. 3B are illustrated in accordance with one approach which is in no way intended to be limiting.

As shown, the multilingual-machine translation model 250 receives application source code and directs it to a renderer 252. The renderer 252 is able to evaluate the application source code (e.g., executable code) and render images of the information that is displayed in a user interface having text in a source language to be translated. In some approaches, the process of generating images may be impacted (e.g., guided) by testing performed. For example, end-to-end tests may produce a list of paths to render and build, e.g., such that elements in the application are each addressable with paths. In other approaches, a helper system configured to mirror real-time interaction with a user interface and capture corresponding screenshots. Thus, only new portions of added elements may be inspected and rendered before being sent to the describer 254.

Images are thereby sent from the renderer 252 to a describer 254. There, the describer 254 includes image to text models that are trained to generate descriptions of elements in images of user interfaces, strings of characters in the images, relationships between the characters in each string and/or different strings, etc. These descriptions are thereby used to generate context for the characters in each of the strings. In some approaches, the describer is configured to use the determined context to decide whether each of the characters in the strings should be translated or not.

The strings and corresponding context are thereby sent from the describer 254 to the translator 256. There, the translator 256 includes one or more text to text models (e.g., LLMs). The translator 256 may thereby evaluate the context received from the describer 254 and translate at least a portion of the strings of characters to a target language. The translator 256 preferably utilizes a learned understanding of: the contexts, cultures associated with the source and target languages, common idioms and phrases used in the particular user interface, contexts of corresponding elements in the user interface, etc., to decide which strings of characters are translated from the source language to a target language, along with how the translation is implemented. However, it should be noted that in approaches having an AI model that is configured to ingest images in addition to text, the describer 254 and the translator 256 could be merged in a single block. A received image may thereby serve as a sufficient information to produce translated strings, e.g., as will be described in further detail below.

From the translator 256, the translated strings and corresponding context are sent to the mapper 258. There, the mapper 258 may also include a text to text model (e.g., LLM) that is configured to identify specific portions of the application source code that pertain to the translated portions of the strings. For instance, the mapper 258 may evaluate the contextual details received from the translator 256 in order to identify the specific sections of the application source code that should reflect the translated strings. In some approaches, the mapper 258 may provide source locations to implement modified (e.g., translated) code by using an additional sub-system to replace strings with unique identifiers, allowing for rendered code strings to appear identifiably in a given context.

The mapper 258 is also illustrated as being connected directly to the renderer 252. The mapper 258 may thereby receive a full copy of the application source code to modify. The mapper 258 outputs a translated version of the application source code. This translated version may be transferred to remote locations (e.g., remote compute systems) for implementation, stored in memory, used as a base copy to create software copies for a given region, etc.

Referring back now to FIG. 2A, electronic device 206 includes a processor 216 coupled to memory 218. The processor 216 is also connected to a display screen 224, a computer keyboard 226, a computer mouse 228, a microphone 230, a camera 232, and an audio speaker 234. Accordingly, the processor 216 may receive inputs from user 207 using one or more of: the display screen 224 (e.g., using keys of a virtual computer keyboard, a touch screen, etc.), the computer keyboard 226, the computer mouse 228, the microphone 230, and/or the camera 232. The processor 216 may thereby be configured to receive inputs (e.g., text, sounds, images, motion data, etc.) from any of the components in electronic device 206, as entered by the user 207. These inputs typically correspond to information presented on the display screen 224 while the entries were received. Moreover, the inputs received may impact the information shown on display screen 224, data stored in memory 218, information collected from the microphone 230 and/or camera 232, status of an operating system being implemented by processor 216, etc.

Electronic device 206 also includes a machine learning module 238 which may be used to inspect software (e.g., programs). In preferred approaches, the machine learning module 238 includes machine learning models that have been trained to automatically generate high quality context-aware machine translations of software. Accordingly, in some approaches the machine learning module 238 may be used to evaluate and/or modify programs downloaded over network 210, received from central server 202, loaded from memory 218, etc. The machine learning module 238 in electronic device 206 may thereby be used in some implementations to interpret and translate the statements in a software program, by performing one or more of the operations in method 300 below, e.g., as will soon become apparent.

Now referring to FIG. 3A, a flowchart of a computer-implemented method 300 for automatically generating high quality translations of software based applications is shown according to one embodiment. The method 300 may be performed in accordance with the present invention in any of the environments depicted in FIGS. 1-2, among others, in various embodiments. Of course, more or less operations than those specifically described in FIG. 3A may be included in method 300, as would be understood by one of skill in the art upon reading the present descriptions.

Each of the operations in method 300 may be performed by any suitable component of the operating environment using known techniques and/or techniques that would become readily apparent to one skilled in the art upon reading the present disclosure. For example, in some implementations one or more of the operations in method 300 may be performed by a controller and machine learning module (e.g., see processor 216 and machine learning module 238, and/or processor 212 and machine learning module 213, of FIG. 2A above). In various other implementations, the method 300 may be partially or entirely performed by a controller, a processor, etc., or some other device having one or more processors therein.

The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3A, operation 302 of method 300 includes receiving a request to inspect application source code. As alluded to above, requests to inspect source code may be received from users, running applications, a remote location over a network, etc. It should also be noted that “application source code” is intended to include any desired type of software code written in any language that would be apparent to one skilled in the art after reading the present description.

In some instances, the source code being evaluated may be received along with the request in operation 302. For instance, a software program may be attached to a request to inspect the code and evaluate the contents. In other approaches, the software program may be stored in memory, e.g., at a location referenced in the received request, and accessed in order to satisfy the request.

In response to receiving the request, method 300 proceeds to operation 304 where the application source code referenced in the received request is inspected. Specifically, operation 304 includes generating application images from the application source code. In some approaches, a renderer is used to inspect the application source code and generate the application images.

Referring momentarily now to FIG. 3B, exemplary sub-operations of generating application images from the application source code, are illustrated in accordance with one approach. It follows that one or more of these sub-operations may be used to perform operation 304 of FIG. 3A. However, it should be noted that the sub-operations of FIG. 3B are illustrated in accordance with one approach which is in no way intended to be limiting.

As shown, sub-operation 330 includes determining a list of application paths to render. In other words, sub-operation 330 includes identifying the extents of the application source code to evaluate and translate. In preferred approaches, the extents of the application source code are identified using a renderer that is configured to evaluate the request initially received and extract the corresponding application paths (e.g., see renderer 252 in FIG. 2B above). In some approaches, the list of application paths is derived from testing (e.g., end-to-end tests) that is performed on the application. According to a non-limiting example, end-to-end tests from an existing test suite may be performed and used to identify application paths to render and/or how they pertain to corresponding source code.

From sub-operation 330, the flowchart advances to sub-operation 332. There, sub-operation 332 includes determining a list of dynamic behaviors to support in the application paths. In other words, sub-operation 332 includes identifying the actions taken in response to following (e.g., performing) the identified application paths. Again, sub-operation 332 may be performed by a renderer in some approaches.

The flowchart further proceeds to sub-operation 334 from sub-operation 332. There, sub-operation 334 includes producing application images which correspond to the application paths and dynamic behaviors. In some approaches, the application images are snapshots taken of an environment displaying a user interface produced as a result of running application source code. In other approaches, the application source code itself may be inspected by one or more AI based models that are configured to render user interface display information in response to inspecting application source code.

Returning now to FIG. 3A, method advances from operation 304 to operation 306. There, operation 306 includes using the application images to generate strings of characters (in a source language) to be translated. Operation 306 also includes generating context associated with the different strings of characters. In preferred approaches, the strings of characters and/or the context associated therewith is generated (e.g., produced) using a describer (e.g., see describer 254 in FIG. 2B above).

Referring momentarily now to FIG. 3C, exemplary sub-operations of generating strings of characters to be translated, and/or the corresponding context, are illustrated in accordance with one approach. It follows that one or more of these sub-operations may be used to perform operation 306 of FIG. 3A. However, it should be noted that the sub-operations of FIG. 3C are illustrated in accordance with one approach which is in no way intended to be limiting.

As shown, sub-operation 350 includes examining received application images. In other words, application images received from a renderer may be used as inputs to AI based models trained to identify text-based characters therein. Moreover, sub-operation 352 includes using an image-to-text model to output strings of alphanumeric characters from the application images to be translated. In preferred approaches, the image-to-text model is generated and/or trained by a describer element in an AI based model.

From sub-operation 350, the flowchart advances to sub-operation 352. There, sub-operation 352 includes using an image-caption model to output the context associated with the strings of alphanumeric characters. In other words, sub-operation 352 includes extracting context from the application images and correlate the context with specific characters in the strings. Context may be extracted from images by comparing pixel arrangements, image metadata, etc., to determine supplemental information about the images and the information displayed therein.

Proceeding from sub-operation 352 to sub-operation 354, a configurable rule engine is used to identify certain ones of the characters to translate, and certain ones of the characters to avoid translating. In other words, sub-operation 354 includes determining which portions of the characters in the strings should be translated. In some cases, strings of characters may not be rich datapoints (e.g., may be null) and therefore are preferably not translated in order to conserve compute throughput and improve efficiency overall. Accordingly, the rule engine may be able to identify specific characters to translate.

Moreover, sub-operation 356 includes outputting strings of characters along with their respective context, e.g., as text strings. In other words, each of the strings of characters are output along with the corresponding context that provides insight thereto. For example, the context may specify certain sections of the character strings to translate, and specify other sections of the character strings to avoid translating. Again, training an AI based model to selectively avoid certain characters while performing the translation desirably reduces the compute overhead and improves performance of the compute system as a whole.

Returning now to FIG. 3A, method 300 advances from operation 306 to operation 308. There, operation 308 includes using the strings of characters and context to produce high quality context-based translations of the strings of characters in a target language. In other words, the character strings and context determined in operation 306 correspond to a source human language and are used in operation 308 to automatically generate context-based translations of desired (e.g., specific) portions of the character strings, the translations being in a target human language. It follows that in preferred approaches, the target language is a human language that is different than the human language of the strings of characters being translated. For example, the translations may be from English to Spanish, English to French, Mandarin to Italian, etc. In some approaches, the context-based translations of the desired characters is performed using a translator that employs a text-to-text translation model.

However, in preferred approaches, the process of using the strings of characters and context to produce high quality context-based translations of strings of characters in a target human language includes using a multilingual-machine translation model to translate the text elements. The multilingual-machine translation model is preferably trained to incorporate (e.g., understand and consider) the context associated with the strings of characters, details of the source language, details of the target language, etc. It follows that the multilingual-machine translation model may be an AI based model trained in an application domain in some approaches. However, any type of multilingual-machine translation model which would be apparent to one skilled in the art after reading the present description may be implemented.

With continued reference to FIG. 3A, method 300 advances from operation 308 to operation 310. There, operation 310 includes causing a mapper to update the application source code with the translations. In other words, operation 310 includes modifying the application source code to implement the translations that have been produced. Referring now to FIG. 3D, exemplary sub-operations of updating the application source code with the translations are illustrated in accordance with one approach. It follows that one or more of these sub-operations may be used to perform operation 310 of FIG. 3A. However, it should be noted that the sub-operations of FIG. 3D are illustrated in accordance with one approach which is in no way intended to be limiting.

As shown, sub-operation 370 includes generating a mapping of the translated strings of characters to source locations in the application source code. In other words, sub-operation 370 includes determining how and/or where the translated character strings correlate with the received (e.g., original) application source code. This may be determined by examining the contextual information received for the character strings that have been translated.

In some approaches, the process of generating the mapping of translated text elements to respective source locations in the source code involves using a renderer. For example, a renderer may be applied to a copy of the source code in which the characters in the strings are replaced with unique strings. The renderer may thereby use the unique strings to determine the respective source locations for the translated elements. The unique strings may further be modified as outlined in the context associated with the strings of characters.

From sub-operation 370, the flowchart advances to sub-operation 372. There, sub-operation 372 includes applying the translated string of characters to the application source code according to the mapping. In other words, sub-operation 372 includes updating the source application code with the translated strings of characters according to the mapping. This preferably results in the application source code producing information in the user interface that is phrased (e.g., presented) in a desired target language. Accordingly, sub-operation 374 includes outputting a translated application source code.

It follows that in some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to inspect application images and output strings of characters (e.g., alphanumeric elements) to be translated; inspect strings of characters to be translated and output the context associated with the strings of characters; etc. The rendered images may thereby be used by the AI based models as context for producing the high-quality machine translations. Initial training may include reward feedback that may, in some approaches, be implemented using a base model that generally understands application source code. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with application source code, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from translations made of characters extracted from application source code. Such an AI model ensures that accuracy of the translations is maintained, where the scale of such analysis and determinations would not otherwise be feasible for a human to perform. This is because humans are not able to efficiently balance the impact different translations have on application source code functionality, and would otherwise incorporate processing delays and errors in the process of attempting to do so. Accordingly, management of operations described herein is not able to be achieved by human manual actions.

In some approaches, outputs produced by the renderer, describer, and/or translator components may be made available to developers. For example, outputs produced by the renderer, describer, and/or translator components may be combined (e.g., averaged over a period of time, compared against patterns identified by AI based models, etc.) and made available to (e.g., transmitted to, printed out for, displayed on a screen, etc.) human code developers. In other words, outputs produced by the renderer, describer, and/or translator components may be converted into one or more desired human languages. The renderer is preferably able to render application images by replacing source strings with unique strings that can be mapped back from screen captures to source locations. The application may further employ translation files that are generated by approaches herein. Some approaches may further use the system to test the quality of existing code translations, e.g., rather than to create new code translations.

It should also be noted that one or more of the operations included herein may be applied in order to verify existing translations in addition to creating new translations. For instance, a request to compare an existing source code sample with an existing translated code sample in an existing target language may be received. The request may be received as a step in retraining one or more AI based models that may have been used to generate the translation and/or evaluate how other systems translate from a source language to a target language. Accordingly, the existing source code sample and/or the existing translated code sample may be used to generate application images, e.g., using any approaches included herein. These application images may further be used to generate existing strings of characters to be translated from the source code sample. In other words, the received existing translated code is evaluated by generating a new translation of the source code sample.

Context associated with the existing strings of characters is also generated. Moreover, the existing strings of characters and context are used to produce context-based translations of the existing strings of characters, the translations being in the existing target language. Furthermore, the context-based translations of the existing strings of characters are compared with the existing translated code sample received. In response to determining that the received existing translated code sample shares a sufficient number of similarities (e.g., a number of overlapping data points or vectors) with the context-based translations of the existing strings of characters that are generated, approaches herein are able to certify that the existing source code sample and existing translated code sample include information that conveys (e.g., displays in a graphical user interface) a same contextual statement in different human languages.

In some approaches, changes to user interface strings may be reviewed and/or suggested using approaches described herein. In some approaches, a reviewer component may be implemented in combination with the translator element. For example, a reviewer element may: inspect outputs produced by the describer, review the quality of the strings, and make suggestions for improvements. This may be configured as an assistant to content designers in some instances.

Some approaches may optionally enable user overrides of translations. Accordingly, a user may be able to edit the translated (e.g., output) source code, and those changes may further be provided as an input to a mapper for future evaluation. This may also be used to determine how a produced string is associated with an input location.

Still other approaches may implement reverse mapping. For instance, some instances associate each source string with a unique string (e.g., filename_linenumber). Source strings may be identified by simple detection of string constants (e.g., single, double, smart quotes, etc.) and/or using compiler-type code (e.g., lexical analysis, parsing, etc.). Thus, for each screenshot created by the renderer, a corresponding screenshot may be created with the unique strings. Moreover, by providing both screenshots to the describer, the associated unique string can be added for each string as part of the respective context (e.g., metadata). Following translation of a string, the original source location may thereby be easily identified by inspecting the associated unique strings.

Preferred approaches herein include a pipeline of several stages that evaluate application source code as an input. The application source code results in information being presented in a user interface, the information being presented in English according to an example. The pipeline desirably produces the same user interface code where the text of the elements is now in a target language, e.g., such as French. The pipeline stages that achieve this include a renderer which leverages the executable derived for the source code, and renders a set of screens that cover all UI elements whose text is to be translated.

The pipeline stages also include a describer which takes application screens as input, and uses an image-to-text model for generating strings to be translated in the images with their associated context. The stages also include a translator which employs a text-to-text translation model which is provided with strings and context as input, and produces high quality context-based translations in the target language as output. The pipeline stages further include a mapper which updates the application source code with translated text. By combining these stages into a pipeline, approaches herein are able to produce automatic high-quality translations of user interfaces.

Approaches herein thereby include methods that combine: rendering screens of a user interface to produce sources of context for translation; describing the context of each element from the screens (e.g., image to text); translating the text of each user interface element taking its context into account; and mapping the translations back into their proper place in the source code (or translation files) to create translated source code. To achieve this, the renderer takes a list of application paths to be rendered and list of dynamic behaviors (e.g., such as mouse hover on a particular UI element). From this information, the renderer produces application images which reflect the application paths and dynamic behaviors. The list of application paths may be derived from end-to-end tests of the application, where the tests may be from an existing test suite, or by other means.

Moreover, the describer takes images as input and uses an image-to-text model for determining the text elements to translate. In some approaches, the describer uses an image-caption model to determine the context of each text element being translated in the image. As an output, the describer produces the text elements to be translated, along with their associated context. The describer may also utilize a configurable rule engine to determine which text strings should be translated and which should not.

The translator takes text to be translated, and its associated context given as output by the describer. The translator also takes information associated with the source and target languages as input. A multilingual-machine-translation model is implemented to translate the text elements by understanding their UI context and the source and target translation languages. The translator thereby produces high quality translations of the text elements in the target (e.g., desired) language.

The mapper takes the translations of text elements produced by the translator and outputs an updated copy of the application source code. In other words, the mapper replaces the text elements in the source code with their corresponding translations in the target language. Mapping of translated text elements to their source location may be determined by running the renderer on a version of the source code in which the text in each text element is replaced by a unique string from which the source location can be determined. The Describer adds the unique string to the context of each text element. If the application is written with translation files, the mapper populates the translation file in the target language by mapping translations to the correct keys.

It follows that the describer is a driver for rich context in approaches herein. The describer outputs a description of the UI and the interactions of that UI in enough detail to allow one skilled in the art to recreate the functionality and key visual elements of the UI in response to reading the present description. From this, an intelligent (e.g., trained) translator may be able to understand the semantics associated with the various UI elements and provide high quality translations regarding language and culture. Thus, rather than associating UI labels with elements they are tied to (e.g., headers, buttons, etc.) approaches herein are able to leverage richer forms of “expression” that are produced in the domain of generative AI models. For example, the input to the describer can be walkthroughs of the UI (e.g., driven by visual test cases), and the output can be a textual description of what is happening on the screen (e.g., “when you click the button labelled ‘Trace’ it shows a loading indicator then renders a page with the header ‘Trace results’”).

Some approaches augment the system with domain knowledge for increasing accuracy of the translations, where domain knowledge can be learned by the system by exposing it to documentation pages that contains pertinent terminology. Accordingly, in some approaches the translator may be trained in the application domain by providing it product documentation pages. As a result, a more specialized translator is produced that is more of a domain expert, which is able to achieve desired translation quality while maintaining system efficiency.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating application images from application source code;
using the application images to generate strings of characters in a source language to be translated;
generating context associated with the strings of characters;
using the strings of characters and context to produce context-based translations of the strings of characters in a target language; and
causing a mapper to update the application source code with the translations.

2. The method of claim 1, wherein the generating application images from application source code includes:
determining a list of application paths to render;
determining a list of dynamic behaviors to support in the application paths; and
producing application images which correspond to the application paths and dynamic behaviors.

3. The method of claim 2, wherein the list of application paths is derived from end-to-end tests of the application.

4. The method of claim 1, wherein the generating the strings of characters and the generating the context associated with the strings of characters includes:
examining the application images;
using an image-to-text model to output strings of characters to be translated;
using an image-caption model to output the context associated with the strings of characters; and
outputting the strings of characters and their respective context.

5. The method of claim 4, wherein the generating the strings of characters and the generating the context associated with the strings of characters further includes:
using a configurable rule engine to identify certain ones of the characters to translate, and certain ones of the characters to avoid translating.

6. The method of claim 1, wherein the using the strings of characters and context to produce the context-based translations of the strings of characters in the target language includes using a multilingual-machine translation model trained to incorporate the context associated with the strings of characters, the source language, and the target language.

7. The method of claim 6, wherein the multilingual-machine translation model is an AI based model trained in an application domain.

8. The method of claim 1, wherein updating the application source code with the translations includes:
generating a mapping of the translated strings of characters to source locations in the application source code;
applying the translated string of characters to the application source code according to the mapping; and
outputting a translated application source code.

9. The method of claim 8, wherein the generating the mapping includes:
applying a renderer to a copy of the source code in which the characters in the strings are replaced with unique strings, from which the respective source locations are determined; and
adding the unique strings to the context associated with the strings of characters.

10. The method of claim 9, wherein outputs produced by the renderer, a describer, and a translator are made available to developers.

11. The method of claim 1, further comprising, in response to receiving a request to compare an existing source code sample with an existing translated code sample in an existing target language:
generating application images from the existing source code sample;
using the application images from the existing source code sample to generate existing strings of characters to be translated;
generating context associated with the existing strings of characters;
using the existing strings of characters and context to produce context-based translations of the existing strings of characters in the existing target language; and
comparing the context-based translations of the existing strings of characters with the existing translated code sample.

12. A computer program product comprising:
one or more computer-readable storage media; and
program instructions stored on the one or more storage media to perform operations comprising:
generating application images from application source code;
using the application images to generate strings of characters in a source language to be translated;
generating context associated with the strings of characters;
using the strings of characters and context to produce context-based translations of the strings of characters in a target language; and
causing a mapper to update the application source code with the translations.

13. The computer program product of claim 12, wherein the generating application images from application source code includes:
determining a list of application paths to render;
determining a list of dynamic behaviors to support in the application paths; and
producing application images which correspond to the application paths and dynamic behaviors.

14. The computer program product of claim 12, wherein the generating the strings of characters and the generating the context associated with the strings of characters includes:
examining the application images;
using an image-to-text model to output strings of characters to be translated;
using an image-caption model to output the context associated with the strings of characters; and
outputting the strings of characters and their respective context.

15. The computer program product of claim 14, wherein the generating the strings of characters and the generating the context associated with the strings of characters further includes:
using a configurable rule engine to identify certain ones of the characters to translate, and certain ones of the characters to avoid translating.

16. The computer program product of claim 12, wherein the using the strings of characters and context to produce the context-based translations of the strings of characters in the target language includes using a multilingual-machine translation model trained to incorporate the context associated with the strings of characters, the source language, and the target language, wherein the multilingual-machine translation model is an AI based model trained in an application domain.

17. The computer program product of claim 12, wherein updating the application source code with the translations includes:
generating a mapping of the translated strings of characters to source locations in the application source code;
applying the translated string of characters to the application source code according to the mapping; and
outputting a translated application source code.

18. A computer system comprising:
a processor set;
one or more computer-readable storage media; and
program instructions stored on the one or more storage media to cause the processor set to perform operations comprising:
generating application images from application source code;
using the application images to generate strings of characters in a source language to be translated;
generating context associated with the strings of characters;
using the strings of characters and context to produce context-based translations of the strings of characters in a target language; and
causing a mapper to update the application source code with the translations.

19. The computer system of claim 18, wherein the generating application images from application source code includes:
determining a list of application paths to render;
determining a list of dynamic behaviors to support in the application paths; and
producing application images which correspond to the application paths and dynamic behaviors.

20. The computer system of claim 18, wherein the generating the strings of characters and the generating the context associated with the strings of characters includes:
examining the application images;
using an image-to-text model to output strings of characters to be translated;
using an image-caption model to output the context associated with the strings of characters; and
outputting the strings of characters and their respective context.
